(19) United States
(12) Patent Application Publication
(10) Pub. No.: US 2022/0238943 A1
(43) Pub. Date: Jul. 28, 2022

(54) COMBINED POWER SUPPLY

(71) Applicants: SERHII VICTOROVYCH DENYSENKO, Kyivska obl. (UA); Daniel TONKOPIY, Kyivska obl. (UA)

(72) Inventors: SERHII VICTOROVYCH DENYSENKO, Kyivska obl. (UA); Daniel TONKOPIY, Kyivska obl. (UA)

(21) Appl. No.: 17/610,550

(22) PCT Filed: Apr. 21, 2020
(86) PCT No.: PCT/UA2020/000046

§ 371 Date: Nov. 11, 2021

(30) Foreign Application Priority Data
May 29, 2019 (UA) U 2019 05905

(51) Int. Cl. H01M 16/00; H02J 7/00; H02J 7/34; H01M 10/0525; H01M 50/204; H01M 50/224; H01M 50/249; H01M 10/48; H01M 10/42

(52) U.S. Cl. CPC H01M 16/00; H02J 7/0047; H02J 7/345; H02J 7/0029; H01M 10/0525; H01M 2010/4271; H01M 50/224; H01M 50/249; H01M 10/486; H01M 10/425; H01M 2220/20; H01M 50/204

(57) ABSTRACT

The combined power supply contains an accumulator battery and a supercapacitor. It contains a universal battery module, made in the form of a metal box which is mounted to the frame of the electric bicycle, and in the middle of which is placed an accumulator battery with a charge protection unit connected to the active battery balancer. A supercapacitor connected to a supercapacitor converter/balancer that is coupled to a current sensor coupled to an overload protection unit of a universal module coupled to a downconverter. The active battery balancer is connected to the battery monitor and controller which is also coupled to the supercapacitor converter battery monitor, temperature sensor, and data exchange module.

### CROSS REFERENCE TO RELATED APPLICATION

This application is a national stage entry of PCT/UA2020/000046 filed Apr. 21, 2020, under the International Convention and claiming priority over Ukraine Patent Application No. u 2019 05905 filed Apr. 29, 2019.

### FIELD OF THE INVENTION

The invention relates to the field of electrical engineering and power electronics, in particular to combined power sources and can be used in vehicles, namely electric bicycles.

### BACKGORUND OF THE INVENTION

Electric vehicles typically use lithium batteries due to their high specific energy capacity.

But despite all the advantages, these types of batteries have a number of disadvantages: the temperature dependence of power the thermal loses of the battery at high loads, the degradation of the batteries and a significant reduction in battery life under heavy load, such as starting a vehicle from a constant place repeated in the urban cycle of operation. The disadvantage is also the inability to use all the accumulated battery power. The main energy of the battery is spent on the movement of the vehicle, but when braking, this energy is consumed irrevocably. That is, in the stop-start mode significant energy loses occur. This is the so-called urban driving cycle: «The UN/ECE Elementary Urban Cycle» [https://en.wikipedia.org/wiki/New_European_Driving_Cycle].

In some cases, braking energy recovery is used when the electric motor is running in generator mode. This allows to reverse some of the motion energy in the battery. But while braking a lot of energy in a short amount of time is produced. Since the lithium-ion battery is a chemical source of current, it cannot be recharged quickly—accordingly, the energy obtained from the motor in the recovery mode transforms back to heat.

For this reason, it is proposed to use a supercapacitor in parallel with a lithium battery as a power source.

[symbol]

Supercapacitor (ionistor, ultracapacitor)—capacitor with limited or unlimited electrolyte “covers” in which there is a double electric layer at the interface between the electrode and the electrolyte. The specific capacitance of the supercapacitor reaches dozen F/cm³ at a nominal voltage of 2-4 V.

The main disadvantage of the supercapacitor as an independent power source is the linear coulomb voltage characteristic. The voltage at the terminals of the supercapacitor varies proportionally to its charge, while the voltage at the battery terminals at its discharge by half should fall by no more than 5%. Thus, only a small fraction of the already stored energy is working. In addition, high self-discharge does not allow the supercapacitor to remain on for a long time.

However, the supercapacitor draws attention to the fact that its disadvantages are «cross» to the disadvantages of lithium-ion batteries. Using both of these elements in the power supply can eliminate virtually all of these defects.

The use of an active energy balancing system is known from the art, which can work both on charge and on discharge. Unlike classic balancing systems, where battery cell alignment occurs due to the discharge of batteries, in active balancing, energy from more charged cells can also be transferred to less charged ones. This reduces battery power consumption during charge and discharge [https://www. kit-e.ru/preview/pre_21_3_14_lpbs.php].

The disadvantage is that such systems are first designed for a specific type of battery from a particular manufacturer that is, are not universal and secondly have a high cost and long development time.

One of the components of the system is control electronics, to which the active balancing function is transmitted to enable it at the necessary times. Management must be exercised by functioning system [https://en.wikipedia.org/wiki/Battery_management_system].

### DETAILED DESCRIPTION OF THE INVENTION

In addition to ⋅managing the main battery units, the electronic system also performs protection and monitoring functions. The measured parameters can be transmitted to the serial bus for logging and sending to a remote server. The information collected can be used to improve battery performance algorithms alert users to critical conditions, or for professionals servicing the vehicle. Such a system is in short an industrial single-board computer that is already widely used to automate production.

Currently, manufacturers of electronic components produce a wide range of solutions to implement different approaches to building such active systems.

The closest analogue of the invention known from the art is a stabilized combined power source, which contains terminals for connecting an external charger, an ionistor (supercapacitor) with a controllable element at the input, a device for stabilizing the voltage on the load, the backup energy accumulator-battery, battery voltage relay battery which are introduced respectively into the battery circuit of the battery and the ionistor, as well as the stabilized voltage converters as devices for stabilizing the voltage on the load, each of which is the entrance controlled electronic key, and the battery voltage relay provides additional tipper contact you put into the general supply chain of stabilized voltage converters [Patent No. RU2488198CI; H01M 10/00; 2013]

The disadvantage of the closest analogue is that the supercapacitor is used solely as a backup power source for spacecraft, and therefore the system as a whole is not designed to work under load as part of the power unit of the vehicle.

### OBJECT AND SUMMARY OF THE INVENTION

The object of the invention is to increase the reliability and energy efficiency of the combined power supply as part of the power unit of the bicycle.

This object is solved by the fact that the combined power supply containing a accumulator battery and a supercapacitor, in accordance with the invention contains a universal battery module made in the form of a metal box which is mounted on the frame of the electric bicycle, and in the middle of which is placed the accumulator battery with the protection unit, protecting from the recharge coupled to an active accumulator battery balancer, a supercapacitor connected to a supercapacitor converter/balancer connected to a current sensor coupled to a protection unit protecting from the universal module overloading, connected to the power supply unit thedownconverter, with the active accumulator battery balancer connected to the accumulator battery monitor and the controller, which is also connected to the supercapacitor converter, the accumulator battery monitor, temperature sensor and the data exchange module.

As the accumulator battery It IS proposed to use lithium ion battery.

The combined power supply reduces the impact of battery disadvantages, namely, reducing energy loses when accelerating and decelerating an electric bicycle,and increasing the run on a single charge of the battery. It is also essential to extend the battery life by balancing the load.

The use of the power source, in addition to the accumulator battery, an additional supercapacitor energy storage, provides high reliability, protection of the accumulator battery from the action of extreme discharge currents, more complete use of stored energy over a wide temperature range, as well as in several times Increasing the long-term use of the accumulator battery.

The combination of structural elements allows for maximum mileage and reliability of the electric bicycle, as well as providing additional service functions such as recording accumulator battery data, which helps to identify faults.

### BRIEF DESCRIPTION OF DRAWINGS

The invention is illustrated by drawings, where:

FIG. 1 shows a block diagram of a combined power supply;

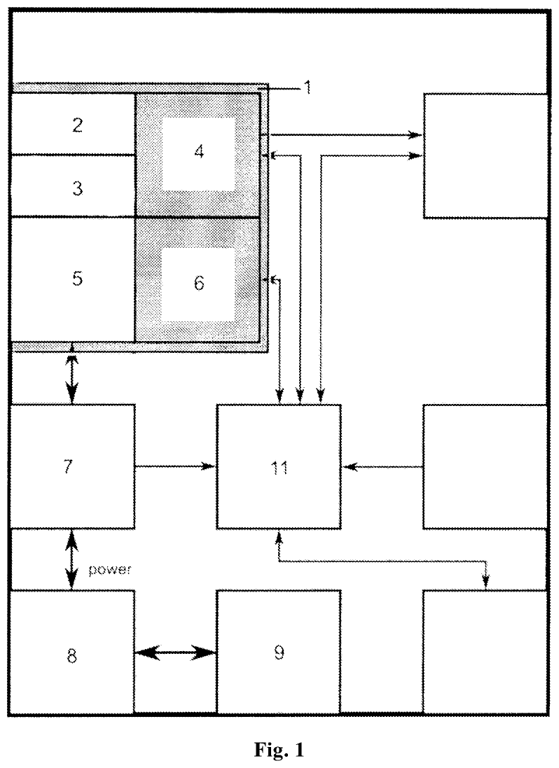

FIG. 2 shows a general view of the combined power supply.

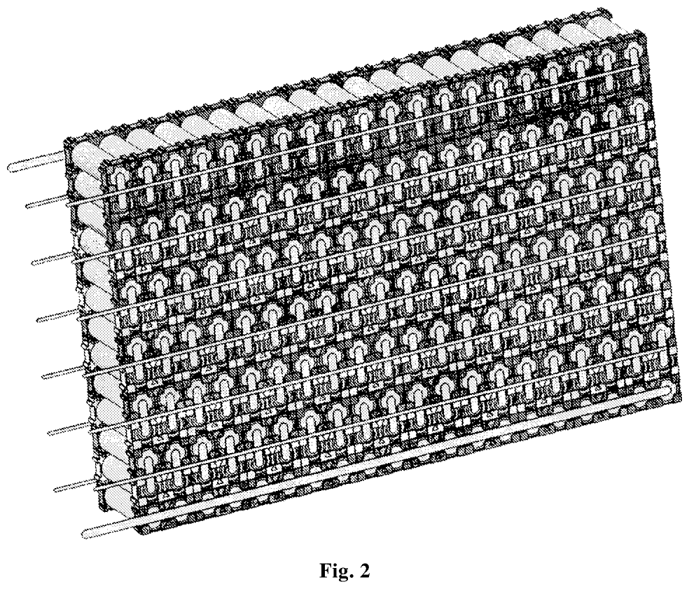

Combined power supply contains a universal battery module (I) made in the form of a metal box, which is mounted on the frame of the electric bicycle, and in the middle of which is placed the accumulator battery (2) (lithium ion) with the protection unit (3), protecting from the recharge coupled to an active accumulator battery balancer (4), a supercapacitor (5) connected to a supercapacitor converter/balancer (6). Supercapacitor (5) is connected to a current sensor (7) coupled to a protection unit (8) protecting from the universal module (I) overloading, connected to the power supply unit (9)—the downconverter. The active accumulator battery balancer (4) connected to the accumulator battery monitor (10) and the controller (11), which is also connected to the supercapacitor converter (6) the accumulator battery monitor (10), temperature sensor (12) and the data exchange (13) module—CAN interface.

The combined power supply operates as follows.

In the Initial phase the acceleration of the electric bicycle is due to the energy of the supercapacitor (5), and at the moment when the rotor of the electric bicycle reaches the necessary rotation the electric motor of the bicycle switches to accumulator battery (2), and the supercapacitor (5) at this time is energized. Energy recovery is also actively used. When the electric bicycle is braking and the engine is in recovery mode, the current starts flowing from the engine to the accumulator battery (2). If the supercapacitor (5) is not fully charged, the charging converter charges the supercapacitor (5) until full charging or stopping of the engine as a source of energy. Since supercapacitor (5) can be charged quickly, losses during recovery will be minimal. Since the supercapacitor (5) and the converter/balancer (6) have low internal resistance, the energy losses to heat the components will be minimal. Measuring the engine consumption and acceleration of the electric bicycle, the controller (11) triggers the charge or discharge of the supercapacitor (5). When the engine consumption is positive and the speed of the vehicle increases, the supercapacitor (5) begins to discharge. In the opposite situation, when the engine is running as a generator, the supercapacitor (5) begins to consume additional energy.

1. A combined power supply comprising:
an accumulator battery;
a supercapacitor,
a universal battery module, made in the form of a metal box, which is mounted on the frame of the bicycle, and in the middle of which is placed an accumulator battery with the protection unit, protecting from the recharge coupled to an active accumulator battery balancer,
a supercapacitor connected to a supercapacitor converter/balancer;
a supercapacitor is connected to a current sensor coupled to a protection unit protecting from the universal module overloading, connected to the power supply unit—the downconverter; the active accumulator battery balancer connected to the accumulator battery monitor and the controller, which is also connected to the supercapacitor converter the accumulator batte1Y monitor, temperature sensor, and the data exchange module.

2. The combined power supply according to claim 1, wherein the lithium-ion battery is used as the accumulator battery.
